(19) United States
(12) Patent Application Publication
(10) Pub. No.: US 2007/0244728 A1
(43) Pub. Date: Oct. 18, 2007

(54) SYSTEM AND METHOD FOR COMPREHENSIVE CUSTOMIZED UMRAH TRAVEL PLANNING

(76) Inventor: Zavid Bhaiyat, Laurel, MD (US)

Correspondence Address: Gibb & Rahman, LLC, 2568-A RIVA ROAD SUITE 304, ANNAPOLIS, MD, 21401, US

(21) Appl. No.: 11/279,417

(22) Filed: Apr. 12, 2006

(51) Int. Cl. G06Q 10/00

(52) U.S. Cl. 705/5

(57) ABSTRACT

A system and method of providing a computer-generated customized umrah travel package for a user, wherein the method comprises establishing a computer-generated user profile stored on a host site; selecting customizable umrah travel package parameters stored on the host site, wherein the umrah travel package parameters comprise lodging data, lodging ratings data, local transportation data, amenity data, distances to main attraction data, travel passport data, and umrah travel package pricing data; consolidating customized umrah travel details based on the computer-generated user profile and the selected customizable umrah travel package parameters; and allowing the user to purchase a customized umrah travel package based on the consolidated umrah travel details.

### BACKGROUND

1. Technical Field

The embodiments herein generally relate to computer-related technology, and, more particularly, to computerized travel planning systems, methods, and databases.

2. Description of the Related Art

In the Islamic faith, umrah is religious pilgrimage to Mecca (also referred to as Makkah), Saudi Arabia performed by Muslims from all over the world. While not mandatory, umrah is performed by millions of pilgrims every year and may be undertaken at any time of the year. Typically, when individuals perform umrah, they also seek to travel to other cities in Saudi Arabia including Medina in order to visit historical and religiously significant sites there as well. For many pilgrims, especially those living outside of Saudi Arabia, the point of entry into the country is one of the major cities of Saudi Arabia having an airport such as Riyadh, Jeddah, or Medina, with Jeddah being by far the most heavily-used airport for pilgrims arriving/departing Saudi Arabia and for coordinated travel to other areas of the country.

One of the significant challenges of performing umrah is coordinating a travel package to Saudi Arabia. In this context, the process of acquiring traveling means to/from Saudi Arabia (i.e., airline tickets to/from Saudi Arabia) is one of the easier steps in the overall travel process. In fact, purchasing airline tickets to/from Saudi Arabia can be performed by anyone with or without the assistance of a travel agent or Saudi government official. The major obstacles in coordinating an umrah travel package generally occur in the processes of acquiring lodging once in Saudi Arabia, acquiring local transportation to/from various locations within Saudi Arabia, as well as submitting passport and entry visa requests with Saudi Arabian government officials. These obstacles are due, in part, to the recent changes promulgated by the Saudi Arabian government that restrict pilgrims to act as their own agents for making hotel reservations, and local travel reservations. In fact, the Saudi Arabian government has instituted a practice of establishing Saudi Arabian agents within Saudi Arabia who are licensed to facilitate the reservation making on behalf of pilgrims. These Saudi Arabian agents work with the government officials in the Saudi Arabian Hajj Ministry to manage a pilgrim's stay in Saudi Arabia.

In order to better serve over a billion potential pilgrims, the government of Saudi Arabia has allowed the establishment of national local agents in several foreign countries including the United States that act as local travel agents for pilgrims from that particular country who wish to perform umrah. These local travel agents, who are also licensed by the Saudi Arabian government, act as intermediaries between pilgrims and the Saudi Arabian agents and correspondingly the Saudi Arabian Hajj Ministry.

However, these local travel agents also face the daunting task of coordinating umrah travel packages for their customer clients due to the restrictions imposed by the Saudi Arabian government for travel to/from and within Saudi Arabia. In fact, one of the major obstacles for the local travel agents is coordinating a customized umrah travel package for its clients as different clients have different requests and budgets for their travel requests. Accordingly, there remains a need for a technique that facilitates the customized coordination of an umrah travel package to allow a pilgrim to enter Saudi Arabia, travel within the country, establish temporary lodging once in Saudi Arabia, and perform his/her religious duties during umrah.

### SUMMARY

In view of the foregoing, an embodiment herein provides a method and service of providing a computer-generated customized umrah travel package for a user, and a program storage device readable by computer, tangibly embodying a program of instructions executable by the computer to perform the method of providing a computer-generated customized umrah travel package for a user, wherein the method comprises establishing a computer-generated user profile stored on a host site; selecting customizable umrah travel package parameters stored on the host site, wherein the umrah travel package parameters comprise lodging data, lodging ratings data, local transportation data, amenity data, distances to main attraction data, travel passport data, and umrah travel package pricing data; consolidating customized umrah travel details based on the computer-generated user profile and the selected customizable umrah travel package parameters; and allowing the user to purchase a customized umrah travel package based on the consolidated umrah travel details.

The method may further comprise purchasing the customized umrah travel package; and requesting required travel documentation from the user. Additionally, the method may further comprise purchasing the customized umrah travel package; initiating an electronic umrah travel request from the user to a licensed umrah travel agent associated with the host site; and instructing the licensed umrah travel agent to process the umrah travel request. Moreover, the method may further comprise sending the processed umrah travel request to a licensed umrah host-country umrah travel agent; and requesting an entry visa for entering the umrah host country.

Preferably, the method further comprises establishing a category of the user, wherein the category of the user comprises any of an individual customer and an agent for the individual customer. Also, the method may further comprise the any of the individual customer and the agent for the individual customer establishing the user profile for a plurality of travelers. Furthermore, the method preferably comprises automatically calculating a price of the customized umrah travel package on a continual basis during the selection of the customizable umrah travel package parameters; and presenting an updated balance of the price to the user as the selection of the customizable umrah travel package parameters are modified.

Additionally, the method may further comprise consolidating multiple customized umrah travel packages for a plurality of users; and consolidating multiple computer-generated user profiles for a plurality of users. Moreover, the method may further comprise allocating a commission to the agent for purchases of the customized umrah travel package. Also, the method may further comprise presenting price allocations attributed to the customized umrah travel package, wherein the price allocations comprise first type charges assessed by the licensed umrah host-country umrah travel agent and second type charges assessed by the host site; and presenting currency conversions for converting the first type charges from the umrah host-country currency to an alternate currency.

Another embodiment provides a system for providing a computer-generated customized umrah travel package for a user, wherein the system comprises a client site adapted to facilitate networked interaction with a user; a host site in communication with the client site, wherein the host site comprises a computer-generated user profile; modules comprising customizable umrah travel package parameters, wherein the umrah travel package parameters comprise lodging data, lodging ratings data, local transportation data, amenity data, distances to main attraction data, travel passport data, and umrah travel package pricing data; a consolidator adapted to consolidate customized umrah travel details based on the computer-generated user profile and the selected customizable umrah travel package parameters; and a selector adapted to allow the user to purchase a customized umrah travel package based on the consolidated umrah travel details.

The system may further comprise means for purchasing the customized umrah travel package; and means for requesting required travel documentation from the user. Moreover, the system may further comprise means for purchasing the customized umrah travel package; means for initiating an electronic umrah travel request from the user to a licensed umrah travel agent associated with the host site; and means for instructing the licensed umrah travel agent to process the umrah travel request. Additionally, the system may further comprise means for sending the processed umrah travel request to a licensed umrah host-country umrah travel agent; and means for requesting an entry visa for entering the umrah host country.

Preferably, the system further comprises means for establishing a category of the user, wherein the category of the user comprises any of an individual customer and an agent for the individual customer. Also, the system may further comprise means for the any of the individual customer and the agent for the individual customer establishing the user profile for a plurality of travelers. Moreover, the system may further comprise a calculator adapted to automatically calculate a price of the customized umrah travel package on a continual basis during a selection of the customizable umrah travel package parameters; and a graphic user-interface adapted to present an updated balance of the price to the user as the selection of the customizable umrah travel package parameters are modified.

Furthermore, the system preferably comprises means for consolidating multiple customized umrah travel packages for a plurality of users; and means for consolidating multiple computer-generated user profiles for a plurality of users. Furthermore, the system may further comprise means for allocating a commission to the agent for purchases of the customized umrah travel package. Additionally, the system may further comprise means for presenting price allocations attributed to the customized umrah travel package, wherein the price allocations comprise first type charges assessed by the licensed umrah host-country umrah travel agent and second type charges assessed by the host site; and means for presenting currency conversions for converting the first type charges from the umrah host-country currency to an alternate currency.

Another embodiment provides a system for providing a computer-generated customized umrah travel package for a user, wherein the system comprises means for establishing a computer-generated user profile stored on a host site; means for selecting customizable umrah travel package parameters stored on the host site, wherein the umrah travel package parameters comprise lodging data, lodging ratings data, local transportation data, amenity data, distances to main attraction data, travel passport data, and umrah travel package pricing data; means for consolidating customized umrah travel details based on the computer-generated user profile and the selected customizable umrah travel package parameters; and means for allowing the user to purchase a customized umrah travel package based on the consolidated umrah travel details.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system block diagram according to an embodiment herein;

FIG. 2 illustrates a schematic diagram of an umrah travel planning system according to an embodiment herein;

FIGS. 3 through 6 are flow diagrams illustrating preferred methods according the embodiments herein;

FIG. 7 illustrates a computer architecture diagram according to an embodiment herein; and

FIG. 8 is another flow diagram illustrating a preferred method according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

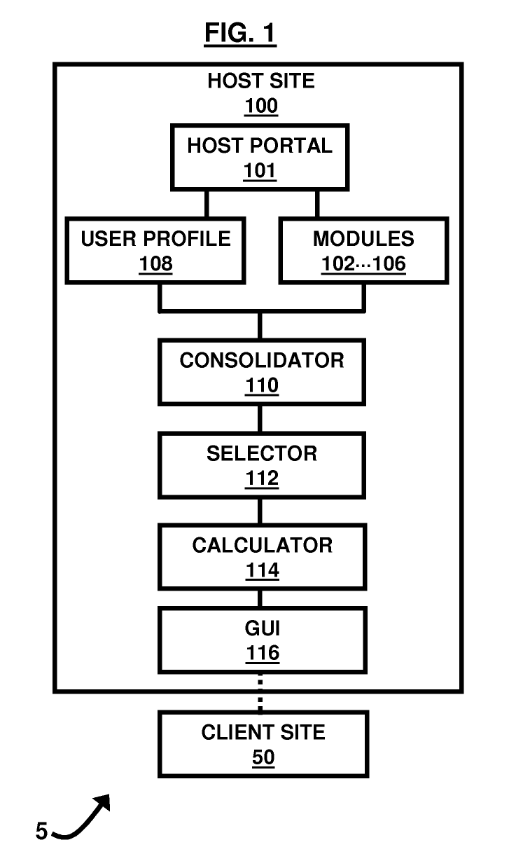

As mentioned, there remains a need for a technique that facilitates the customized coordination of an umrah travel package to allow a pilgrim to enter Saudi Arabia, travel within the country, establish temporary lodging once in Saudi Arabia, and perform his/her religious duties during umrah. The embodiments herein achieve this by providing a system, method, and service for providing a computer-generated customized umrah travel package for a user. Referring now to the drawings, and more particularly to FIGS. 1 through 8, where similar reference characters denote corresponding features consistently throughout the figures, there are shown preferred embodiments.

FIG. 1 illustrates a system 5 for providing a computer-generated customized umrah travel package for a user, wherein the system 5 comprises a client site 50 adapted to facilitate networked interaction with a user; and a host site 100 in communication with the client site 50. The system 5 preferably operates in a web-based environment where a user located at a client site 50 accesses the host site 100, which functions as a database, through a graphic user interface 116 that is presented by the host site 100 and accessible from the client site 50. As the client site 50 interfaces with the host site 100, the user is able to interact with the host portal 101 of the host site 100. The host portal 101 allows the user to access other areas of the system 5 and further interact with the system 5. The host site 100 comprises a computer-generated user profile 108 and modules 102-106 comprising customizable umrah travel package parameters, wherein the umrah travel package parameters comprise lodging data, lodging ratings data, local transportation data, amenity data, distances to main attraction data, travel passport data, and umrah travel package pricing data.

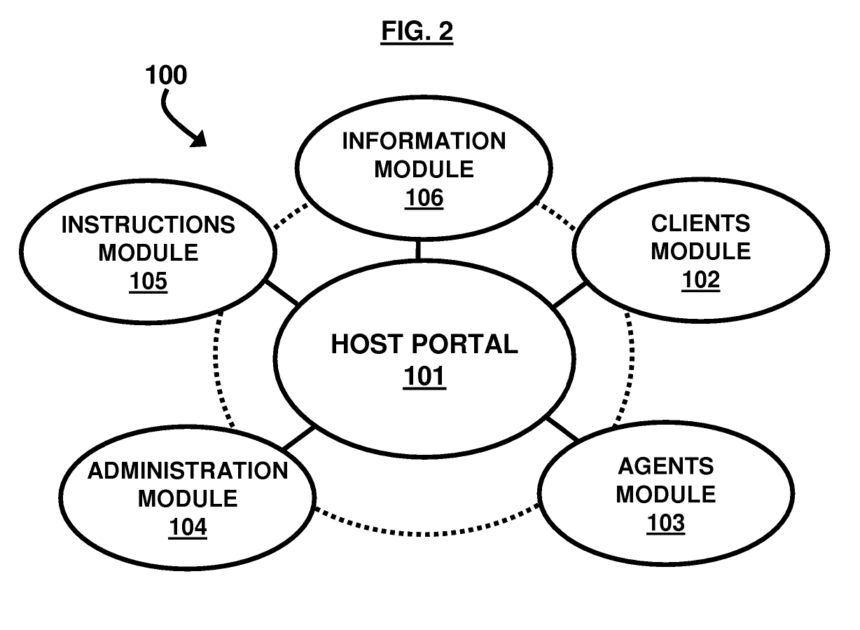

More specifically, as illustrated in FIG. 2, the modules 102-106 comprise a clients module 102, an agents module 103, an administration module 104, an instructions module 105, and an information module 106 all networked together and in communication with one another and accessible through the host portal 101. Upon first entering the host portal 101 the user selects from one of the available modules 102-106. Such a selection can be accomplished by any appropriate means including using a mouse, touch screen, keyboard, or voice direction or any other selection means.

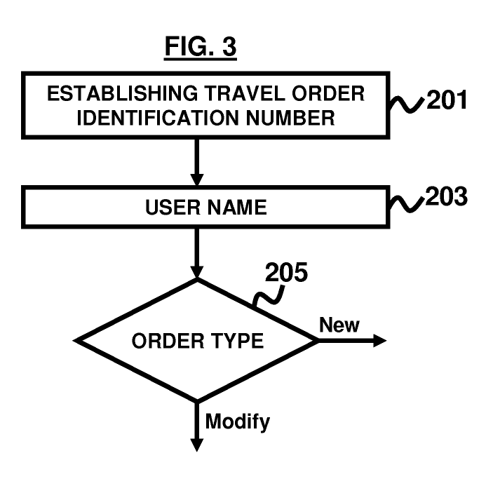

If the user selects the clients module 102, then, as indicated in FIG. 3, the user (most likely the customer/traveler/pilgrim (although these individuals may be different entities)) is requested to establish a travel order identification number 201 and is asked to enter a user name 203. Thereafter, the user reaches a decision point where he/she selects the order type 205 of whether the user is making a new order or is modifying a previously established order. If a new order is being made, then the user enters a user name 203 and then a new identification number 201 is provided. If a modified order is being made, then the user enters a previously-established identification number 201. Irrespective of which order type is selected (new or modified), the process continues to a computer-generated user profile 108 preferably presented in a tabular form. Here, the customer's information is presented. Typically, the user will be the customer, but in some contexts, the user and customer may be different entities. The user profile 108 may comprise a customer's personal information including the customer's title (for example, Dr., Mr., Mrs., Ms., Miss, etc.); the first, middle, and last names; the customer's address; telephone numbers including cellular phone numbers; fax numbers; e-mail address; and any associated websites. Additionally, the desired travel dates are selected as well as the number of individuals who will be traveling with the customer with specific categories for adults, children, and infants. Furthermore, two queries are presented to the user including whether the customer has an airline ticket for traveling from his/her home country to Saudi Arabia and if not, whether the customer desires a price quote to be provided for an airline ticket. Finally, a comment section may be provided to allow the user to enter any additional comments, questions, or clarifications. At this point the user may reset the customer personal information user profile 108 or may proceed to the next step of the process.

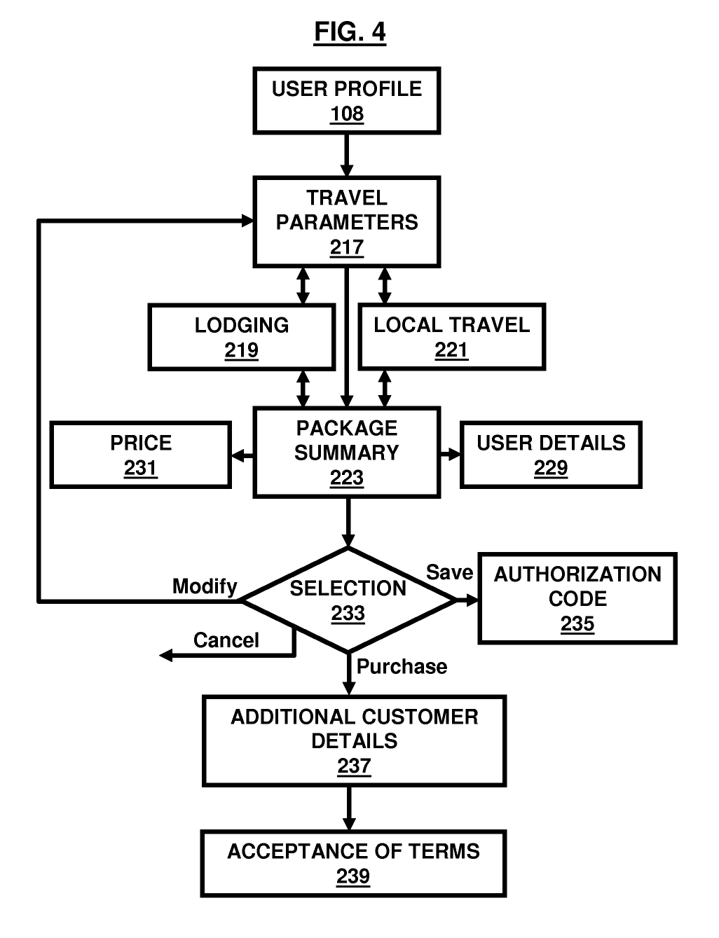

As depicted in FIG. 4, after entering the user profile 108, the user enters the customer's travel parameters 217. Here, lodging data 219 and local travel data 221 are entered into the host site database 100 (of FIGS. 1 and 2). With respect to the lodging data 219, the user may select the desired hotel rating preferably through a drop-down menu system (for example, 1 star, 2 star, 3 star, 4 star, and 5 star ratings, although other rating systems may be utilized) for hotels in various hotel city categories such as Makkah, Medina, and Jeddah. For each of the hotel city categories, a choice is presented to the user corresponding to the name of a particular hotel for a corresponding hotel rating. Additionally, for each of the hotel city categories, a choice is presented for the size of the hotel room (for example, single, double, etc.). Next, the user may select the number of nights that the customer wishes to stay at the respective hotel. Whenever a particular hotel is selected, the system 5 generates amenity data with respect to the particular hotel such as whether breakfast is included, etc. Additionally, the distance between the hotel and the main attraction for a particular city is presented when a particular hotel is selected. For example, the main attraction in Makkah is the “Haram Sharif” (location of the Kabah) and in Medina the main attraction is the “Mosque of the Prophet”. For most pilgrims, a location near the main attraction is desirable. Thus, the user may make changes to their selections in order to have a hotel nearer to the main attraction of a particular city in Saudi Arabia. With respect to the local travel data 221, a user may select the transportation type for traveling once in Saudi Arabia (for example, taxi, private car, bus, limousine, coaster, etc.) as well as the description of the transportation type, which may include information such as the desired circuit for the transportation (for example, from Jeddah to Makkah to Medina to Jeddah or from the airport to Makkah to the airport, etc.).

With respect to FIGS. 1 and 4, after the travel parameters 217 are selected, a travel package summary 223 is provided to the user. This package summary 223 is provided by the consolidator 110 shown in FIG. 1, which is adapted to consolidate the customized umrah travel details based on the computer-generated user profile 108 and the selected customizable umrah travel package parameters such as the customer's lodging data 219, local travel data 221, as well as the user (or customer) details 229 such as customer's name, address, check-in date, and check-out date, etc. Finally, an indicator of the price 231 of the travel package is provided. Here, the price 231 is broken down to the cost per person, and then based on the total number of travelers, the total price of the package is provided in Saudi Arabian riyals as well as in a currency of the user's country of residence (for example, U.S. dollars, etc.).

At this point, the user is presented with a decision point whereby he/she may make a selection 233, using the selector 112 (of FIG. 1), of whether to purchase, save, modify, or cancel the current travel package. The selector 112 is adapted to allow the user to purchase a customized umrah travel package based on the consolidated umrah travel details. If the user desires to save his/her travel package, then he/she is provided with an authorization code 235, which allows the user to resume his travel selection process at a later time whereby all of the data entered thus far in the process is saved in a memory component (not shown) in the host site database 100 (of FIGS. 1 and 2). Whenever the user resumes the process he/she is directed to enter the authorization code 235 in step (201) of the process shown in FIG. 3. Again with respect to the selection process 233 of FIG. 4, if the user desires to modify his/her travel package, then he/she is directed to modify the travel parameters 217. If the user desires to cancel his/her travel package, then the saved data is deleted from the memory component (not shown) in the host site database 100 (of FIGS. 1 and 2) and the user will have to re-enter all of the data entered thus far in the process or enter entirely new data.

If the user desires to purchase his/her travel package, then he/she is presented with a request for additional customer details 237. These details 237 may include the customer's personal information as well as a request for entry of the customer's age, nationality, and passport information including the passport number, passport issue date, passport expiry date, and country of passport issuance. Additionally, the name of the customer's mahram is requested. Generally, a mahram, who must be a male, is the chaperone who is responsible for leading a particular group of pilgrims during their umrah pilgrimage. The first customer's information is entered first followed by subsequent customers (i.e., additional travelers who are part of the travel package). Once all of the customer information 237 is provided, the user may either reset the data (for example, if changes have to be made) or the user may proceed to the next step of the process, which involves accepting the terms 239 of the travel package.

With respect to accepting the terms 239 of the travel package, the user is further asked to accept the terms and conditions provided by the host site 100 (of FIGS. 1 and 2). Moreover, additional questions are posed to the user including (a) whether the user has at least two passport pictures for each person traveling in the travel group; (b) whether the user has proof of vaccination against meningitis; (c) whether the user has completed all travel application forms presented by the host site 100; (d) whether the user has proof of the mahram's relationship to the customer/traveler especially if the customer/traveler is a female. These additional questions are based largely on requirements of the Saudi Arabian government. Once the terms 239 are accepted, the user is directed to make a payment (for example, via credit card, electronic check, or sending a check by mail, etc.).

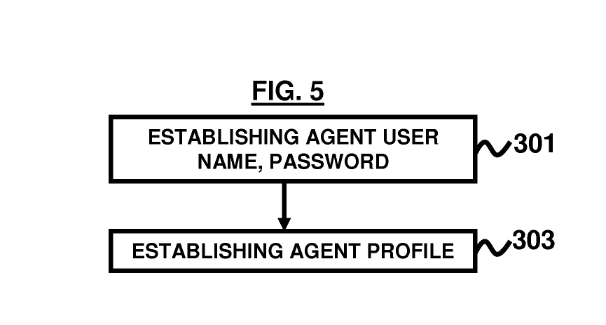

Again with respect to FIG. 2, if the user selects the agents module 103, then, as indicated in FIG. 5, the user is a travel agent and is requested to establish a travel agent user name and password 301 and is asked to establish an agent profile 303. The agent profile 303 includes similar information as presented in the user profile 108 (of FIGS. 1 and 4), but further includes information specific to a travel agent including agent licensing information and whether the agent is selling their own travel package and whether the agent has their own airline ticketing system. A travel agent may use the system 5 (of FIG. 1) if the agent is representing their own customers and is using the system 5 in order to process the travel request. The process that the travel agent follows in terms of entering customer data is similar to the process shown in FIG. 4 and described above.

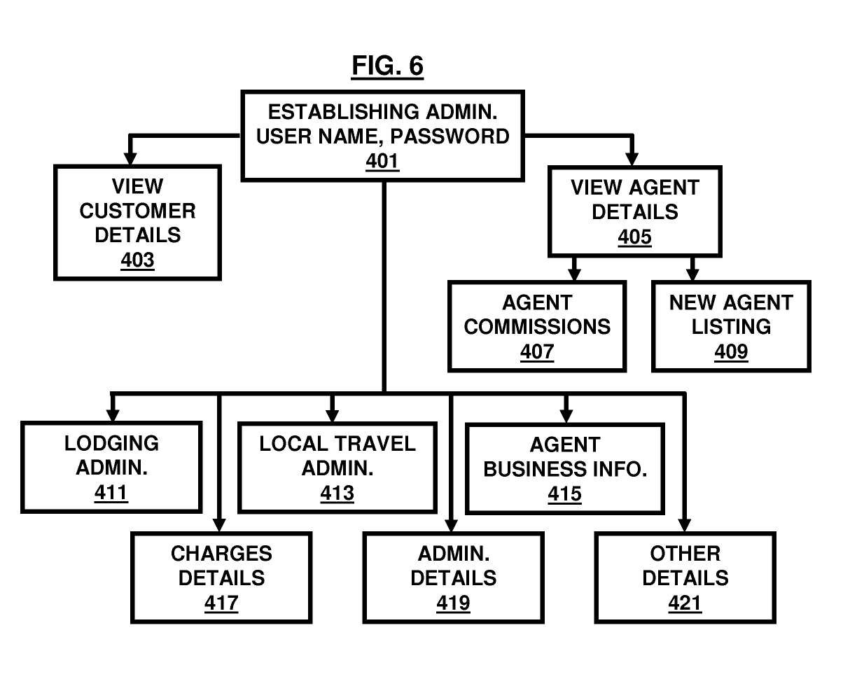

Again with respect to FIG. 2, if the user selects the administration module 104, then, as indicated in FIG. 6, the user is an administrator of the host site 100 (of FIGS. 1 and 2) and is requested to establish an administrator user name and password 401. Once, the user name and passwords 401 are established, the administrator may manage the host site database 100 and may elect to view customer details 403, which includes information on the customer/traveler/pilgrim including the date when the customer/traveler/pilgrim purchased a travel package, the customer's identification number and name, telephone number, number of travelers in the customer's travel group, and the check-in and check-out dates. Here, the administrator may view the specific customer details for a particular customer as well as those individuals traveling with the customer (i.e., sub-customers), and may delete the customer's entry if desired.

The administrator may also view the travel agent details 405 including the travel agents' identification numbers, names, contact information, and status as an active or dormant travel agent, and the administrator may edit or delete the travel agents' entries if desired. In addition to the agent details 405, the administrator may establish a commission system 407 for the agents who are bringing customers to the system 5 (of FIG. 1). Additionally, the administrator may list new agents 409 into the system 5 (of FIG. 1). Furthermore, the administrator may data manage the lodging information 411 and local travel information 413, which respectively provide a listing of all hotels and local modes of transportation available for booking by the customer or agent. Moreover, the administrator may data manage a particular travel agent's business information 415 including viewing those customers listed under a particular travel agent.

Also, the administrator may data manage the details of the price charges 417, which includes the price allocations attributed to charges assessed by the licensed umrah Saudi umrah travel agent (located in Saudi Arabia) and charges assessed by the host site 100 (of FIGS. 1 and 2). The details of the price charges 417 present currency conversions for converting the charges from Saudi riyals to an alternate currency (for example, U.S. dollars) and vice versa. Additional administrator details 419 may be data managed by the administrator including managing user password information. Finally, other details 421 affecting the system 5 may be data managed by the administrator.

Again with respect to FIG. 2, the user may select the instructions module 105, which provides the user with instructions about how to use the system 5 (of FIG. 1) and what the various fields in the various forms presented to the user represent and require in terms of input from the user. Alternatively, with respect to FIG. 2, the user may select the information module 106, which provides additional information to the user including the required documentation that the user needs for his/her travel for umrah as well as information on how to perform the rituals of umrah.

The embodiments herein can take the form of an entirely hardware embodiment, an entirely software embodiment or an embodiment including both hardware and software elements. The preferred embodiment is implemented in software, which includes but is not limited to firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

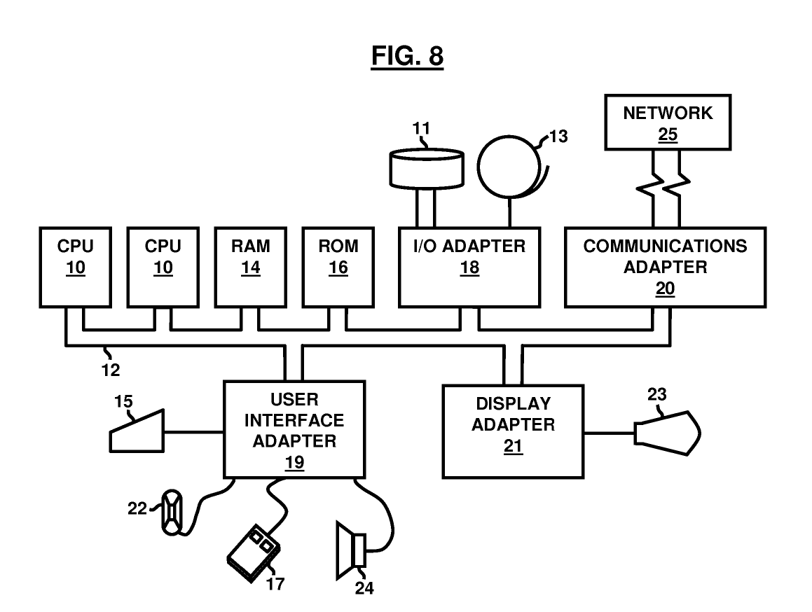

A representative hardware environment for practicing the embodiments herein is depicted in FIG. 8. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

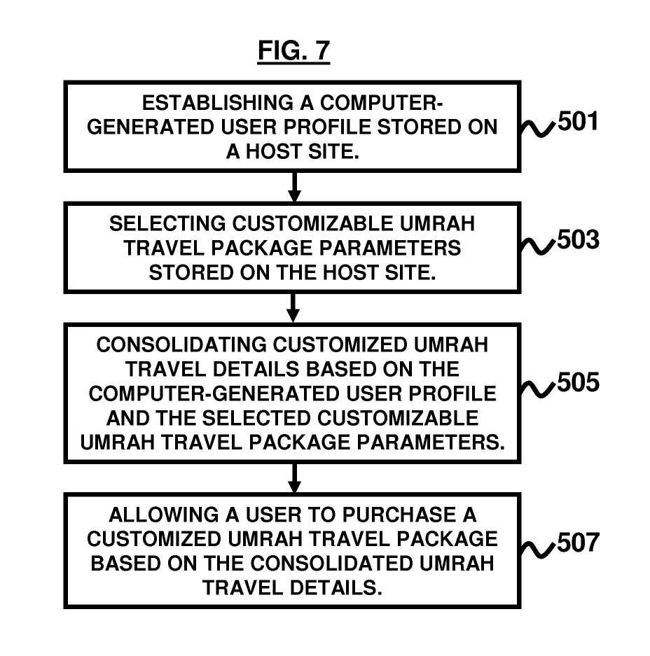

FIG. 8, with reference to FIGS. 1 through 7, illustrates a flow diagram of a method and service of providing a computer-generated customized umrah travel package for a user according to an embodiment herein. The method and service provided by the embodiments herein may be implemented by the system 5 of FIG. 1, wherein the system 5 includes various components (for example, the ones shown in FIG. 1 through 7) as well as other processing means such as software code and computer architecture in order to implement the method, and those skilled in the art would readily understand how to implement such a method and service in the context of the system 5 of FIG. 1 and the computer architecture of FIG. 7 by incorporating various processing means for carrying out the method provided by the embodiments herein.

The method and service preferably comprises establishing (501) a computer-generated user profile 108 stored on a host site 100; selecting (503) customizable umrah travel package parameters 217 stored on the host site 100, wherein the umrah travel package parameters 217 comprise lodging data, lodging ratings data, local transportation data, amenity data, distances to main attraction data, travel passport data, and umrah travel package pricing data; consolidating (505) customized umrah travel details 223 based on the computer-generated user profile 108 and the selected customizable umrah travel package parameters 217; and allowing (507) the user to purchase a customized umrah travel package based on the consolidated umrah travel details 223.

The method may further comprise the user from the client site 50 purchasing the customized umrah travel package; and the host site 100 requesting required travel documentation from the user. Additionally, the method may further comprise the user from the client site 50 purchasing the customized umrah travel package; the host site 100 initiating an electronic umrah travel request from the user to a licensed umrah travel agent associated with the host site 100; and the host site 100 instructing the licensed umrah travel agent to process the umrah travel request. Moreover, the method may further comprise the host site 100 sending the processed umrah travel request to a licensed umrah host-country umrah travel agent (i.e., a licensed umrah travel agent located in Saudi Arabia); and the host site 100 requesting an entry visa for entering the umrah host country (i.e., Saudi Arabia). The entry visa is issued by the Saudi Arabian government and is transmitted back to the licensed umrah host-country umrah travel agent, which, in turn, transmits the issued entry visa back to the host site 100 for proper distribution to the user. Preferably, when the host site 100 receives the umrah travel application, it electronically transmits the application to the licensed umrah host-country umrah travel agent, who in turn transmits the application to the Ministry of Hajj. Thereafter, the Ministry of Hajj processes the application and transmits an approval along with the visa number, wherein one copy is transmitted electronically back to the host site 100 and another identical copy is transmitted to the Saudi embassy located in Washington, DC for processing.

Preferably, the method further comprises establishing a category of the user, wherein the category of the user comprises any of an individual customer and an agent for the individual customer. Also, the method may further comprise that the individual customer or the agent for the individual customer establishes the user profile 108 for a plurality of travelers. Furthermore, the method preferably comprises the host site 100 automatically calculating (using calculator 114 of FIG. 1) a price 231 of the customized umrah travel package on a continual (i.e., on-going) basis during the selection of the customizable umrah travel package parameters; and the host site 100 presenting an updated balance of the price 231 to the user as the selection of the customizable umrah travel package parameters 217 are modified.

Additionally, the method may further comprise the consolidator 110 consolidating multiple customized umrah travel packages for a plurality of users; and the consolidator 110 consolidating multiple computer-generated user profiles 108 for a plurality of users. Moreover, the method may further comprise the administrator associated with the host site 100 allocating a commission to the agent for purchases of the customized umrah travel package. Also, the method may further comprise the host site 100 presenting price allocations attributed to the customized umrah travel package, wherein the price allocations comprise first type charges assessed by the licensed umrah host-country umrah travel agent (i.e., umrah travel agent located in Saudi Arabia) and second type charges assessed by the host site 100; and the host site 100 presenting currency conversions for converting the first type charges from the umrah host-country currency (i.e., Saudi riyals) to an alternate currency (for example, U.S. dollars).

Generally, the embodiments herein provide a customized consolidated user-friendly system 5 that can manage an umrah travel package on behalf of one customer or multiple customers or an agent representing a customer(s) or multiple agents. The embodiments herein facilitate easy data management of the system 5 by an administrator and address a pressing need for umrah pilgrims desiring to go to Saudi Arabia to perform their religious duties. Additionally, the method and system 5 provided by the embodiments herein allow a user to customize his/her umrah travel package in a manner that is easy and in accordance with restrictions imposed by the Saudi Arabian government in terms of how pilgrims are able to establish their travel packages. The embodiments herein allow a consolidated point of access for multiple users and provide the means of overcoming the several obstacles inherent in establishing an umrah travel package.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of providing a computer-generated customized umrah travel package for a user, said method comprising:
establishing a computer-generated user profile stored on a host site;
selecting customizable umrah travel package parameters stored on said host site, wherein said umrah travel package parameters comprise lodging data, lodging ratings data, local transportation data, amenity data, distances to main attraction data, travel passport data, and umrah travel package pricing data;
consolidating customized umrah travel details based on said computer-generated user profile and the selected customizable umrah travel package parameters; and
allowing said user to purchase a customized umrah travel package based on the consolidated umrah travel details.

2. The method of claim 1, further comprising:
purchasing said customized umrah travel package; and
requesting required travel documentation from said user.

3. The method of claim 1, further comprising:
purchasing said customized umrah travel package;
initiating an electronic umrah travel request from said user to a licensed umrah travel agent associated with said host site; and
instructing said licensed umrah travel agent to process said umrah travel request.

4. The method of claim 3, further comprising:
sending the processed umrah travel request to a licensed umrah host-country umrah travel agent; and
requesting an entry visa for entering said umrah host country.

5. The method of claim 1, further comprising establishing a category of said user, wherein said category of said user comprises any of an individual customer and an agent for said individual customer.

6. The method of claim 5, further comprising said any of said individual customer and said agent for said individual customer establishing said user profile for a plurality of travelers.

7. The method of claim 1, further comprising:
automatically calculating a price of said customized umrah travel package on a continual basis during the selection of said customizable umrah travel package parameters; and
presenting an updated balance of said price to said user as said selection of said customizable umrah travel package parameters are modified.

8. The method of claim 1, further comprising:
consolidating multiple customized umrah travel packages for a plurality of users; and
consolidating multiple computer-generated user profiles for a plurality of users.

9. The method of claim 5, further comprising allocating a commission to said agent for purchases of said customized umrah travel package.

10. The method of claim 4, further comprising:
presenting price allocations attributed to said customized umrah travel package, wherein said price allocations comprise first type charges assessed by said licensed umrah host-country umrah travel agent and second type charges assessed by said host site; and
presenting currency conversions for converting said first type charges from said umrah host-country currency to an alternate currency.

11. A system for providing a computer-generated customized umrah travel package for a user, said system comprising:
a client site adapted to facilitate networked interaction with a user;
a host site in communication with said client site, said host site comprising:
a computer-generated user profile;
modules comprising customizable umrah travel package parameters, wherein said umrah travel package parameters comprise lodging data, lodging ratings data, local transportation data, amenity data, distances to main attraction data, travel passport data, and umrah travel package pricing data;
a consolidator adapted to consolidate customized umrah travel details based on said computer-generated user profile and the selected customizable umrah travel package parameters; and
a selector adapted to allow said user to purchase a customized umrah travel package based on the consolidated umrah travel details.

12. The system of claim 11, further comprising:
means for purchasing said customized umrah travel package; and
means for requesting required travel documentation from said user.

13. The system of claim 11, further comprising:
means for purchasing said customized umrah travel package;
means for initiating an electronic umrah travel request from said user to a licensed umrah travel agent associated with said host site; and
means for instructing said licensed umrah travel agent to process said umrah travel request.

14. The system of claim 13, further comprising:
means for sending the processed umrah travel request to a licensed umrah host-country umrah travel agent; and
means for requesting an entry visa for entering said umrah host country.

15. The system of claim 11, further comprising means for establishing a category of said user, wherein said category of said user comprises any of an individual customer and an agent for said individual customer.

16. The system of claim 15, further comprising means for said any of said individual customer and said agent for said individual customer establishing said user profile for a plurality of travelers.

17. The system of claim 11, further comprising:
a calculator adapted to automatically calculate a price of said customized umrah travel package on a continual basis during a selection of said customizable umrah travel package parameters; and
a graphic user-interface adapted to present an updated balance of said price to said user as said selection of said customizable umrah travel package parameters are modified.

18. The system of claim 11, further comprising:
means for consolidating multiple customized umrah travel packages for a plurality of users; and
means for consolidating multiple computer-generated user profiles for a plurality of users.

19. The system of claim 15, further comprising means for allocating a commission to said agent for purchases of said customized umrah travel package.

20. The system of claim 14, further comprising:
means for presenting price allocations attributed to said customized umrah travel package, wherein said price allocations comprise first type charges assessed by said licensed umrah host-country umrah travel agent and second type charges assessed by said host site; and
means for presenting currency conversions for converting said first type charges from said umrah host-country currency to an alternate currency.

21. A program storage device readable by computer, tangibly embodying a program of instructions executable by said computer to perform a method of providing a computer-generated customized umrah travel package for a user, said method comprising:
establishing a computer-generated user profile stored on a host site;
selecting customizable umrah travel package parameters stored on said host site, wherein said umrah travel package parameters comprise lodging data, lodging ratings data, local transportation data, amenity data, distances to main attraction data, travel passport data, and umrah travel package pricing data;
consolidating customized umrah travel details based on said computer-generated user profile and the selected customizable umrah travel package parameters; and
allowing said user to purchase a customized umrah travel package based on the consolidated umrah travel details.

22. A service for providing a computer-generated customized umrah travel package for a user, said service comprising:
establishing a computer-generated user profile stored on a host site;
selecting customizable umrah travel package parameters stored on said host site, wherein said umrah travel package parameters comprise lodging data, lodging ratings data, local transportation data, amenity data, distances to main attraction data, travel passport data, and umrah travel package pricing data;
consolidating customized umrah travel details based on said computer-generated user profile and the selected customizable umrah travel package parameters; and
allowing said user to purchase a customized umrah travel package based on the consolidated umrah travel details.

23. A system for providing a computer-generated customized umrah travel package for a user, said system comprising:
means for establishing a computer-generated user profile stored on a host site;
means for selecting customizable umrah travel package parameters stored on said host site, wherein said umrah travel package parameters comprise lodging data, lodging ratings data, local transportation data, amenity data, distances to main attraction data, travel passport data, and umrah travel package pricing data;
means for consolidating customized umrah travel details based on said computer-generated user profile and the selected customizable umrah travel package parameters; and
means for allowing said user to purchase a customized umrah travel package based on the consolidated umrah travel details.
